(19) United States
(12) Patent Application Publication
(10) Pub. No.: US 2010/0222501 A1
(43) Pub. Date: Sep. 2, 2010

(54) SCALABLE PROCESS FOR SYNTHESIZING UNIFORMLY-SIZED COMPOSITE NANOPARTICLES

(75) Inventors: Vinit S. Murthy, Houston, TX (US); Tildon G. Belgard, Baton Rouge, LA (US); Michael S. Wong, Houston, TX (US)

Correspondence Address: CONLEY ROSE, P.C., 5601 GRANITE PARKWAY, SUITE 750, PLANO, TX, 75024, US

(73) Assignee: WM. MARSH RICE UNIVERSITY, Houston, TX (US)

(21) Appl. No.: 11/464,034

(22) Filed: Aug. 11, 2006

Related U.S. Application Data
(60) Provisional application No. 60/707,259, filed on Aug. 11, 2005.

(51) Int. Cl. C08L 83/04

(52) U.S. Cl. 524/588; 977/750; 977/752; 977/734

(57) ABSTRACT

A method for making composite nanoparticles comprises a) providing an amount of a polyelectrolyte having a charge, b) providing an amount of a counterion having a valence of at least 2, the counterion having a charge opposite the charge of the polyelectrolyte, c) combining the polyelectrolyte and the counterion in a solution such that the polyelectrolyte self-assembles to form a plurality of polymer aggregates, the plurality of polymer aggregates having an average diameter less than about 100 nm, d) adding a precursor to the solution, wherein the precursor has a charge opposite the charge of the polyelectrolyte, and e) allowing the precursor to infuse each polymer aggregate and polymerize so as to produce composite nanoparticles. The composite nanoparticles comprise a polymer aggregate containing at least one polyelectrolyte and at least one counterion and a polymer network crosslinked throughout the polymer aggregate. The polymer network may be inorganic, e.g silicon-containing.

### CROSS-REFERENCE TO RELATED APPLICATIONS

This application claims benefit of U.S. Provisional Application Ser. No. 60/707,259, filed Aug. 11, 2005, and entitled “Scalable Process for Synthesizing Uniformly-Sized Organic-Inorganic Nanoparticles,” which is incorporated by reference in its entirety.

### STATEMENT REGARDING FEDERALLY SPONSORED RESEARCH OR DEVELOPMENT

Not Applicable.

### FIELD OF THE INVENTION

The present invention relates generally to the field of fabricating nanoparticles. More particularly, the present invention relates to a method of making composite nanoparticles using novel self-assembly techniques.

### BACKGROUND OF THE INVENTION

Monodisperse (or uniformly sized) particles of silica (SiO₂) can be prepared through sol-gel chemistry. The range of particle sizes are conventionally defined in the following way: nanoparticles (diameter in 1-100 nm range), sub-micron particles (100-1000 nm range), and micron-sized particles (>1000 nm). In sol-gel chemistry, molecular precursors of silica, such as tetraethylorthosilicate and silicic acid, undergo hydrolysis and condensation reactions, such that the silica precursors crosslink to form an extended network of Si—O—Si bonds Thus, sol-gel chemistry can be considered an inorganic polymerization process.

The standard model for particle formation in the liquid phase is called the La Mer model, which is based on the more general theory of homogeneous nucleation. The basic idea behind homogeneous nucleation is that the concentration of the particle precursor reaches and exceeds the thermodynamic limit of saturation, such that a supersaturated condition is created. This energetically unfavorable system relieves itself of the excess energy by inducing the formation of particles to lower the concentration of the precursor. A real-life example is the formation of fog when moisture-containing air is cooled. This step is called homogeneous nucleation. The thus-formed particles (which are called nuclei) then grow by addition of additional precursor onto the particle surface; this is the growth step. To prevent the agglomeration of the particles, the particle surface must be treated chemically to minimize interparticle contact and attachment, thus avoiding agglomeration. This general concept has been exploited to generate monodisperse nanoparticles of a variety of compositions, such as CdSe nanoparticles (known as quantum dots), metallic nanoparticles, and SiO₂ nanoparticles, by manipulating the formation process to favor a rapid nucleation followed by slow growth. The achievable particle sizes tend to be on the small end of the 1-100 nm size range, however. Larger nanoparticles are more difficult to prepare without losing the monodispersity and without aggregation and/or precipitation occurring.

The Stöber method is the classical liquid-phase synthesis route for monodisperse SiO₂ particles. Through this method and subsequent improvements, submicron particles can be made readily, but monodisperse SiO₂ NPs are more difficult to achieve. Methods have been developed to improve on this aspect with some success by introducing an added ultrasonication step.

Consequently, there remains a need for a simple method to make monodisperse nanoparticles without agglomeration.

### SUMMARY OF THE INVENTION

Methods of making novel composite nanoparticles are described herein. In general, pre-formed, nano-sized polymer aggregates serve as templates for the eventual formation of composite nanoparticles. The size of the polymer aggregates can be easily controlled in the nanoparticle range by selecting the ratio of the polymer and multivalent anion, concentrations of each component, aging time, and temperature, among other synthesis parameters. Uniform in size, these aggregates are contacted with a precursor. Through charge interactions, the precursor infuses the polymer aggregate volume. The higher local concentration of precursor favors the formation of bonds within the polymer aggregate, such that the sol-gel chemistry is accelerated throughout the polymer aggregate. The resulting material is a composite nanoparticle that assumes the size and shape of the polymer aggregate and contains a charged polymer aggregate intermixed with a second polymerized component.

In an embodiment, a method for making composite nanoparticles comprises providing an amount of a polyelectrolyte having a charge. The method further comprises providing an amount of a counterion having a valence of at least 2. The counterion has a charge opposite to the charge of the polyelectrolyte. In addition, the method comprises combining the polyelectrolyte and the counterion in a solution such that the at least one polyelectrolyte self-assembles to form a plurality of polymer aggregates. The polymer aggregates have an average diameter less than 100 nm. Moreover, the method comprises adding a precursor to the solution. The precursor has a charge opposite to the charge of the polyelectrolyte. Furthermore, the method comprises allowing the precursor to infuse each polymer aggregate and polymerize so as to produce composite nanoparticles.

In another embodiment, a composite nanoparticle comprises a polymer aggregate containing at least one polyelectrolyte and at least one counterion. The composite nanoparticle also comprises a polymer network crosslinked throughout said polymer aggregate.

The present composite nanoparticles are different from nanoparticles prepared through other methods (such as gas-phase methods and Stöber' method), in that they have a polymer content, offer a wider range of tunable particle size, possess improved monodispersity, and are available in an unagglomerated state. These differences may offer advantages over the prior art. In addition, the composite nanoparticles formed using the present technique may have charges exposed at the nanoparticle surface. The charged groups would be from the charged polyelectrolyte in the polymer aggregate. These exposed charges may undergo additional reactions after the nanoparticles are formed, opening up new opportunities for the preparation of novel nanostructured materials.

The foregoing has outlined broadly the features and technical advantages of the present invention in order that the detailed description of the invention will be described hereinafter that form the subject matter of the claims of the invention. It should be appreciated by those skilled in the art that the conception and the specific embodiments disclosed may be ready utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more detailed description of the preferred embodiment of the present invention, reference will now be made to the accompanying drawings, wherein:

FIG. 1 illustrates an embodiment of a method for making composite nanoparticles;

FIG. 2 illustrates polyamine aggregate hydrodynamic diameter growth over time as reported by dynamic light scattering as a function of polyallylamine hydrochloride (PAH) concentration (charge ratio R=2.0, trisodium citrate); and

FIG. 3 illustrates polyamine hydrodynamic diameter growth over time as reported by dynamic light scattering as a function of trisodium citrate concentration ([PAH]=0.1 mg/mL); and

FIG. 4 illustrates polyamine aggregate scattering intensity growth over time as reported by dynamic light scattering for R=1.3, [PAH precursor]=0.1 mg/mL; and

FIG. 5 illustrates scattering intensity growth over time as reported by dynamic light scattering for R=1.3, [PAH precursor]=0.1 mg/mL when 2.5 mL silicic acid of the indicated molarity (which is added 30 minutes after adding PAH solution to salt solution) is added to 3.5 mL aggregates; and

FIG. 6 illustrates scattering intensity growth over time as reported by dynamic light scattering for R=1.3, [PAH precursor]=0.1 mg/mL when 1.5 mL silicic acid (from 1 M TMOS in 1 mM HCl) was added to 3.5 mL aggregates 30 minutes after adding PAH solution to salt solution; and

FIG. 7 illustrates SEM images at 100,000× of hybrid nanoparticles from PAH aggregate seeds in order of increasing R (trisodium citrate concentration of precursor aggregate solution) with given diameters and standard deviations based on manual particle sizing of 1,000 particles from images of each sample: (a) R=1.0 (102 μM), 42.5±6.7 nm; (b) R=1.1 (11.2 μM), 48.7±5.7 nm; (c) R=1.2 (122 μM), 73.2±8.8 nm; (d) R=1.3 (132 μM), 96.2±10.5 nm; (e) R=1.4 (143 μM), 107.6±12.7 nm; (f) Size distribution histogram for the above nanoparticles, based on manual particle sizing.

FIG. 8 illustrates TGA traces for hybrid nanoparticles made using precursor solution at R=1.3 (top, 132 μM sodium citrate in 0.1 mg/mL PAH) and R=1.2 (bottom, 122 μM sodium citrate in 0.1 mg/mL PAH); and

FIG. 9 illustrates UV-Vis spectra of a constant concentration of Commassie brilliant blue G added, under acidic conditions, to hybrid nanoparticles, water, sodium citrate salt, PAH, and silicic acid.

### DETAILED DESCRIPTION OF THE PREFERRED EMBODIMENT

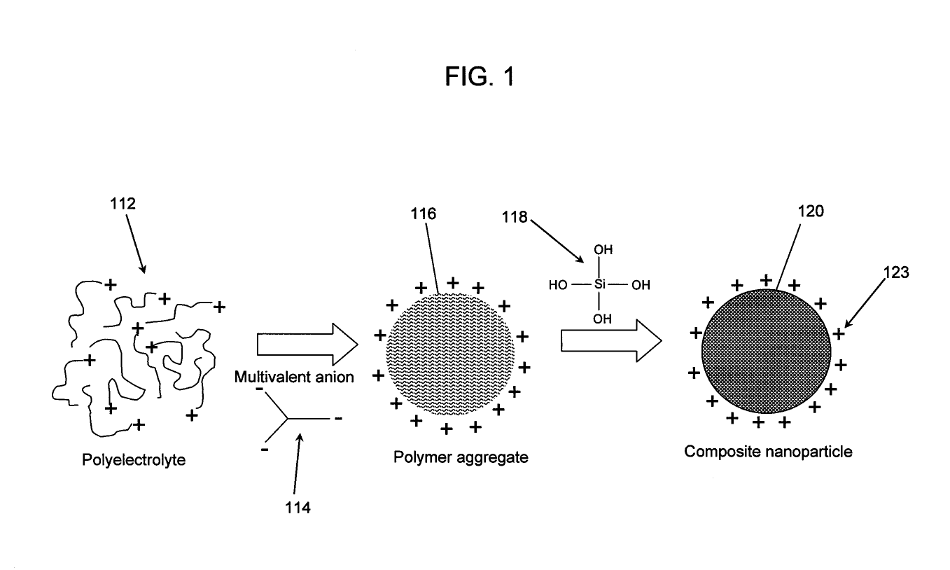

FIG. 1 depicts one embodiment of a method for making composite nanoparticles. In an embodiment, a method for making composite nanoparticles comprises a) providing at least one polyelectrolyte 112 having a charge; b) providing at least one counterion 114 having a valence of at least 2; c) combining the at least one polyelectrolyte 112 and the at least one counterion 114 in a solution so that the at least one polyelectrolyte 112 self-assembles to form a plurality of polymer aggregates 116, said plurality of polymer aggregates 116 having an average diameter less than about 100 nm; and d) adding a precursor 118 to the solution, the precursor having a charge opposite to that of the polyelectrolyte, and e) allowing the precursor 118 to infuse each polymer aggregate 116 and polymerize so as to produce composite nanoparticles 120.

In general, the polyelectrolyte 112 comprises any suitable charged compound. Examples of suitable polyclectrolytes include without limitation, polystyrenesulphonates, polypeptides, polyamines, polyallylamines, polylysine, polyethyleneimine, gelatin, polyacrylic acid, gum Arabic, acacia gum, poly(diallyldimethylammonium) chloride, or combinations thereof. In certain embodiments, the polyelectrolyte has a branched structure. In other embodiments, the polyelectrolyte has a linear structure. Typically, the polyelectrolyte comprises a molecular weight ranging from about 1,000 Da to about 1,000,000 Da, preferably from about 5,000 to about 200,000 Da, more preferably from about 15,000 Da to about 70,000 Da. In preferred embodiments, the polyelectrolyte has a positive charge. Alternatively, the polyelectrolyte has a negative charge. In these embodiments the negatively charged polyelectrolyte can comprise a compound selected from the group consisting of polypeptides, polyacids, polystyrenesulphonates, or combinations thereof thereof. Suitable copolypeptides may be derived from the 20 natural amino acids (lysine, arginine, histidine, aspartic acid, glutamic acid, glycine, alanine, valine, leucine, isoleucine, methionine, proline, phenylalanine, tryptophan, serine, threonine, asparagine, glutamine, tyrosine, and cysteine). In some embodiments, more than one polyelectrolyte compound is provided. For example, polyamine and polylysine both may be used in the method.

In certain embodiments, the method comprises a) providing an amount of a polyelectrolyte having a charge; b) providing an amount of a counterion having a valence of at least 2; c) combining the polyelectrolyte and the counterion in a solution such that the polyelectrolyte self=assembles to form counterion-bridged polymer aggregates having diameters less than 100 nm; and d) adding a silica precursor to the solution and causing the silica precursor molecules arrange themselves throughout the spherical aggregates so as to produce an organic/inorganic particles.

The counterion preferably has a valence of at least 2, more preferably at least 3. However, the counterion may comprise any suitable valence. In an embodiment, the counterion has a negative charge. Moreover, the counterion typically has a charge opposite that of the polyelectrolyte. For example, if the polyelectrolyte has a positive charge, the counterion has a negative charge.

In embodiments in which the counterion has a negative charge, the counterion may comprise a compound selected from the group consisting of carboxylates, phosphates, sulfates, peptides, polypeptides, copolypeptides, or combinations thereof. In addition, the counterion may comprise negatively charged polymers such as without limitation, aspartic acid or glutamic acid. In particular embodiments, the counterion provided is in the form of at least one salt selected from the group consisting of citrates, other carboxylates, sulphates and carbonates and including sodium sulphate, trisodium citrates, trisodium salts of EDTA, tetrasodium salts of EDTA, or combinations thereof. In a preferred embodiment, the counterion is a citrate salt.

In other embodiments, the counterion is positively charged and may comprise peptides, polypeptides, copolypeptides, amines, polyamines, or combinations thereof. In further embodiments, the counterion comprises positively charged polymers including without limitation, lysine, histidine, phosphates, polypeptides, polyacids, polystyrenesulphonates, or combinations thereof. Preferably, these polymers have a molecular weight less than about 1,000 Da. The counterion may also comprise polymers, dendrimers, molecular ions, metal ions, or combinations thereof.

The polyelectrolyte and the counterion are preferably selected and provided such that the overall charge ratio R of total charge attributable to the dissolved salt to total charge attributable to the polymer is equal to or greater than 1.0, more preferably greater than 2, still more preferably greater than 3, and optionally about 10. When the polyelectrolyte is positively charged, R can be expressed as R=[anion]×[z⁻]/[polymer]×[z⁻], where [anion] and [polymer] represent total concentrations, z⁻ is negative charge per anion, and z⁺ is positive charge per polymer chain. In embodiments in which the charges are reversed, the polyelectrolyte is negatively charged and the counterions are cations and R=[cation]×[z⁺]/[polymer]×[z⁻].

In an embodiment, the polyelectrolyte is combined with at least one counterion in solution forming a plurality of polymer aggregates. Alternatively, the polyelectrolyte may be combined with two or more counterions. Without being limited by theory, it is believed that the counterion facilitates self-assembly or flocculation of the polyelectrolyte to form the polymer aggregates.

The polyelectrolyte and the counterion are preferably dissolved in water. However, the polyelectrolyte and the counterion may be dissolved in any other solvent that is capable of dissolving both the polyelectrolyte and the counterion. Examples of other suitable solvents include methanol, ethanol, isopropanol, dimethylformamide, alcohol/water mixtures, or combinations thereof. The synthesis may be carried out over a broad range of temperatures, limited primarily by the solvent. Thus, in some embodiments the preferred temperature range may be between 0° C. and 100° C., preferably 20° C. to 85° C. Moreover, the polyelectrolyte and the counterion may be combined at any suitable pH. In an embodiment, the polyelectrolyte and the counterion are dissolved at a pH in the range of about 3 to about 10, preferably about 4 to about 9, more preferably about 5 to about 8. The pH and temperature of the solution may be varied to alter or tailor the shape and size of the polymer aggregates. In a preferred embodiment, the polymer aggregates are spherical with an average diameter of less than about 100 um. However, the polymer aggregates may be tailored to any shape or size.

The method may also include aging the polymer aggregates prior to the addition of the precursor. As defined herein, aging means allowing the polymer aggregates to sit without agitation. In an embodiment, the polymer aggregates are aged for a period of time ranging from about 1 second to about 12 hours, preferably from about 5 seconds to about 5 hours.

In a further embodiment, a precursor is added to the solution containing the plurality of polymer aggregates. The precursor is preferably a silicon-containing compound. Examples of suitable silicon-containing compounds include silicic acid, tetraethylorthosilicate, tetramethylorthosilicate, silicate salts, 3-aminopropyltriethoxysilane, 3-aminopropyltrichlorosilane, or combinations thereof. In certain embodiments, the method includes preparing or synthesizing the silicon-containing precursor. However, the precursor may comprise any suitable compound. Examples of other suitable compounds include without limitation, metal oxides, metals, organic polymers, or combinations thereof. Alternatively, more than one precursor may be added to the polymer aggregate solution. In an embodiment, the precursor comprises a mixture of a silicon-containing compound and a non-silicon compound. In yet another embodiment, the precursor is an inorganic or organic monomer.

Without being limited by theory, it is believed that the precursor infuses each polymer aggregate volume because of charge interactions between the polymer aggregate and the precursor. Once the precursor impregnates each polymer aggregate, again without being limited by theory, the precursor may bond with the polyelectrolytes of the polymer aggregates via hydrogen bonding and charge interactions. The high concentration of precursor throughout the polymer aggregate promotes the crosslinking or polymerization of the precursor to form a polymer network. Preferably, the precursor polymerizes or crosslinks throughout the polymer aggregate. The end result is the formation of composite nanoparticles comprising a polymerized or crosslinked polymer network intermixed throughout a polymer aggregate template.

In an embodiment, after adding the precursor to the polymer aggregate solution, the precursor-polymer aggregate solution may be vortexed or stirred. The precursor-polymer aggregate solution is then aged, allowing the precursor to fully infuse each polymer aggregate and to polymerize, thus forming the composite nanoparticles. In preferred embodiments, the precursor-polymer aggregate solution is aged for a time period ranging from about 1 minute to about 48 hours. Generally, the precursor-polymer aggregate solution is aged at ambient temperature and neutral pH. However, the precursor-polymer aggregate solution may be aged at any suitable temperature or pH. Without being limited by theory, it is believed that the aging period may be reduced at higher temperatures. That is, the composite particles may form more quickly at increased temperatures.

The resulting composite nanoparticles are typically solid nanoparticles. However, hollow composite nanoparticles may also be prepared with embodiments of the method. Furthermore, the composite nanoparticles are generally spherical in shape. Nevertheless, composite nanoparticles of any shape may be prepared using the described methods. In a preferred embodiment, the composite nanoparticles are inorganic-organic nanoparticles.

Referring back to FIG. 1, the composite nanoparticles 120 prepared by the disclosed method typically have charged outer surfaces 123. Without being limited by theory, it is believed that the charged surface 123 is due to exposed charged groups from the polyelectrolyte. Depending on the charge of the polyelectrolyte, the outer surface of the composite nanoparticles may be negatively or positively charged. In other words, if the polyelectrolyte is positively charged, the outer surface of each composite nanoparticle will also be positively charged and vice versa. The charged nanoparticle surface 123 allows the composite nanoparticles to be easily functionalized with a variety of moieties as will be discussed in more detail below.

In a further embodiment, the method includes applying a shell layer around the composite nanoparticles. The shell layer may impart a desired plasmon resonance to the composite nanoparticle. The composite nanoparticles may be coated with a variety of materials to form the shell layer. Examples include without limitation, metals, metal oxides, metal-nonoxides, organic particles, linear polymer, biomolecules, fullerenols, single/multi-walled carbon nanotubes, or combinations thereof. In a particular embodiment, to form the shell layer, conductive nanoparticles are bound or adsorbed on to each composite nanoparticle to form substrate particles around each composite nanoparticle. Without being limited by theory, each conductive nanoparticle attached as a substrate particle may serve as a nucleation site for the deposition of additional conductive material. The conductive nanoparticles are preferably gold nanoparticles. However, the conductive nanoparticles may be made from any metals or materials that are conductive and are capable of being fashioned into nanoparticles.

According to at least one embodiment, the method includes depositing a conductive material on to the substrate particles to form a shell layer around each composite nanoparticle. Examples of conductive material include without limitation, gold, silver, palladium, platinum, lead, iron, and copper. However any suitable conductive material may be used to coat the composite nanoparticle.

In another embodiment, a metal salt comprising a conductive metal is added to a suspension of composite nanoparticles to form metal nanoshells having a tunable plasmon resonance. For example, a HAuCl₄ salt solution may be added to the hybrid particle surface. However, any suitable metal salt may be used. The metal salt preferably comprises a conductive metal. Examples of conductive metals include without limitation, gold, silver, copper, platinum, or combinations thereof. The conductive metal auto-reduces on to the charged outer surface of the composite nanoparticles thereby forming a composite metal nanoshell. In other words, no additional reducing agent is added or needed to cause reduction of the metal salt. Without being limited by theory, it is believed that the charged polyelectrolyte component in the composite nanoparticles may aid or assist in the auto-reduction of the metal salt.

Alternatively, an additional reducing agent is added to the suspension of composite nanoparticles to reduce the metal salt. In some embodiments, formaldehyde is added with the metal salt to facilitate reduction of the metal on to the nanoparticle surface. In a further embodiment, more metal salt may be added to the composite particle suspension after the initial addition of metal salt to deposit more metal on to the nanoparticle surface.

In further embodiments, the method includes functionalizing the composite nanoparticles with any suitable bioactive moieties. Examples of suitable moieties include without limitation, organic molecules, biomolecules, organic fluorophores, peptides, receptors, ligands, antibodies, proteins, enzymes, or combinations thereof. Other applications for composite nanoparticles include without limitation, scratch-resistant coatings, textiles, inks, adhesives, and batteries, as well as gene therapy, lasers, nanoshell-based diagnostics and therapeutics, catalysis, filtration, or drug delivery.

To further illustrate various illustrative embodiments of the present invention, the following examples are provided.

### Example 1

### Synthesis of Composite Silica Nanoparticles

Monodisperse polyamine aggregates were created using low concentrations of poly(allylamine) hydrocholoride (PAH, Sigma, 70 kDa) and trisodium citrate. Size was controlled from about 30 nm to over 100 nm by varying salt concentration, with the higher concentrations of multivalent, anionic salt creating larger aggregates. The solution was prepared such that, at 100% ionic dissociation of both the chloride from the polymer and the citrate from the sodium, the ratio of negative to positive ionic charges in the solution of citrate and polymer would be a value certain R, varied between 1.0 and 1.4. This was done by adding 1 mL of 0.1 mg/ml, PAH to 2.5 mL trisodium citrate solution. After size growth leveled off at 30 minutes, a solution of silicic acid was added to these stable aggregates, locking in the spherical structure through sol-gel condensation within the aggregates. Silicic acid was prepared by mixing a 1 M solution of tetramethyl orthosilicate (TMOS) in 1 mM HCl. After mixing for 20 minutes to promote hydrolysis, 1 mL of this solution of silicic acid was added to the 3.5 mL citrate-PAH solution. The scattering intensity of these particles was found to increase with time as they were left in the solution of silicic acid. This intensity growth reached a steady state at 2.5 hours after addition of silicic acid, and the solution was centrifuged at 160,400×g for one hour at room temperature to isolate nanoparticles for further characterization.

Theoretical overall charge ratio, R, was used to describe concentrations of polymer and salt in the aggregate system. R was defined as ([anion]×|\tilde{Z}|/([polymer]×|Z+|) where Z is the charge of each molecule at 100% dissociation (for trisodium citrate and 70 kDa PAH, \tilde{Z}=−3 and Z+=749).

Characterization of the suspension and the composite nanoparticles was done through dynamic light scattering (DLS), thermogravimetric analysis, scanning electron microscopy (SEM), and transmission electron microscopy (TEM). For SEM, 25 microliters of suspension was deposited on the sample stub and dried overnight. After drying overnight, the sample was sputter coated with gold. SEM was carried out in JEOL6500 field emission microscope equipped with in-lens thermal field emission electron gun. Secondary electron image (SEI) was taken at 15 kV electron beam with a working distance of 10.0 mm.

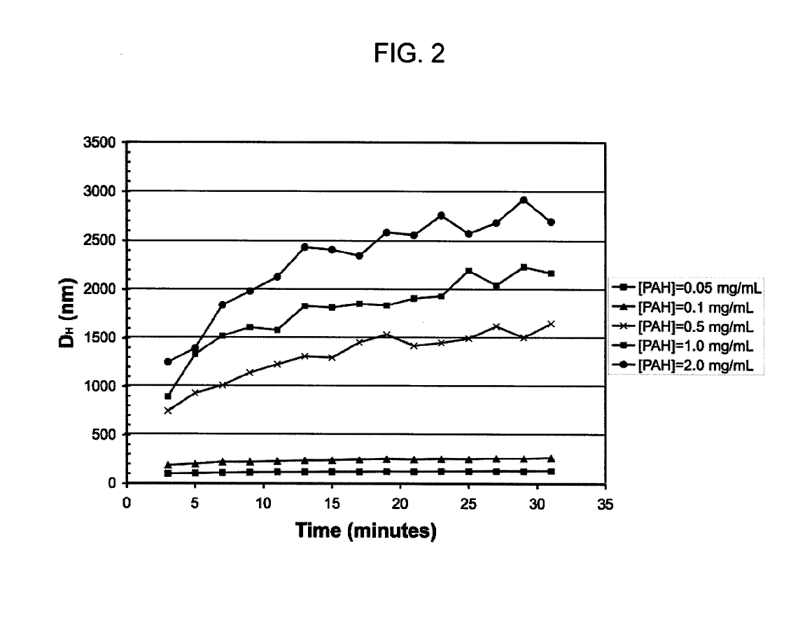

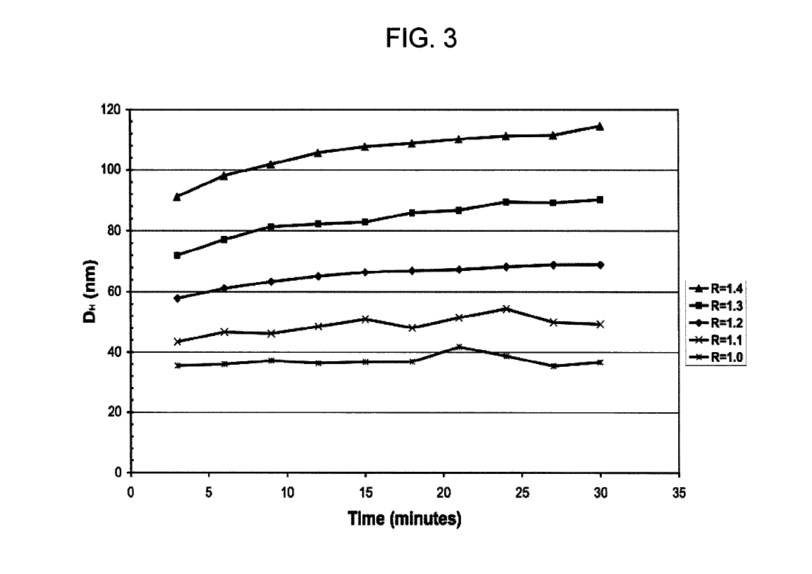

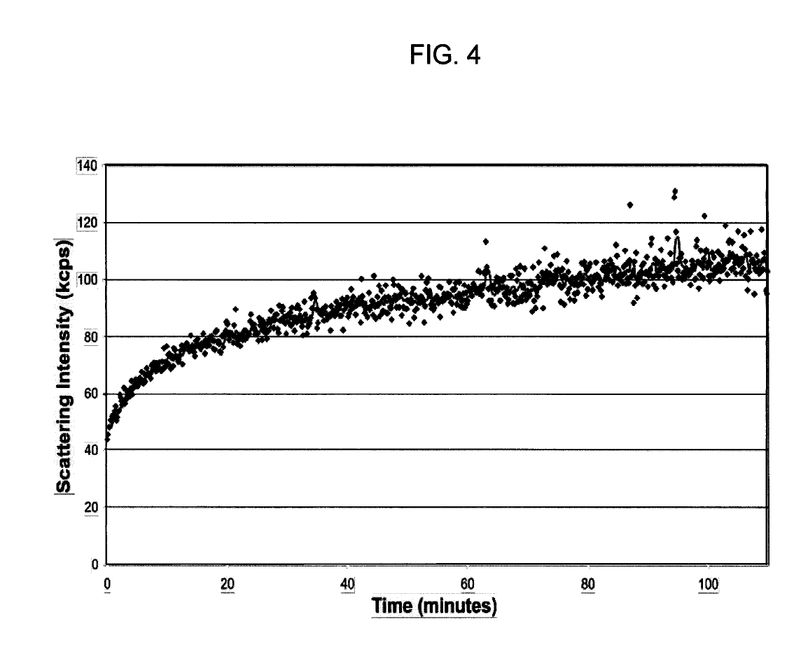

It was found that at sufficiently low concentrations of PAH (29 μg/mL) and sodium citrate (100-150 μM), these aggregates are small (40 to 100 nm) and monodisperse. Higher citrate concentrations lead to larger aggregates than do smaller concentrations. Dynamic light scattering (DLS) measurements revealed that aggregate hydrodynamic diameters increased with time, quickly at first and progressively slower thereafter (FIG. 2, FIG. 3). This growth was nearly complete after half an hour to two hours at room temperature (FIG. 4).

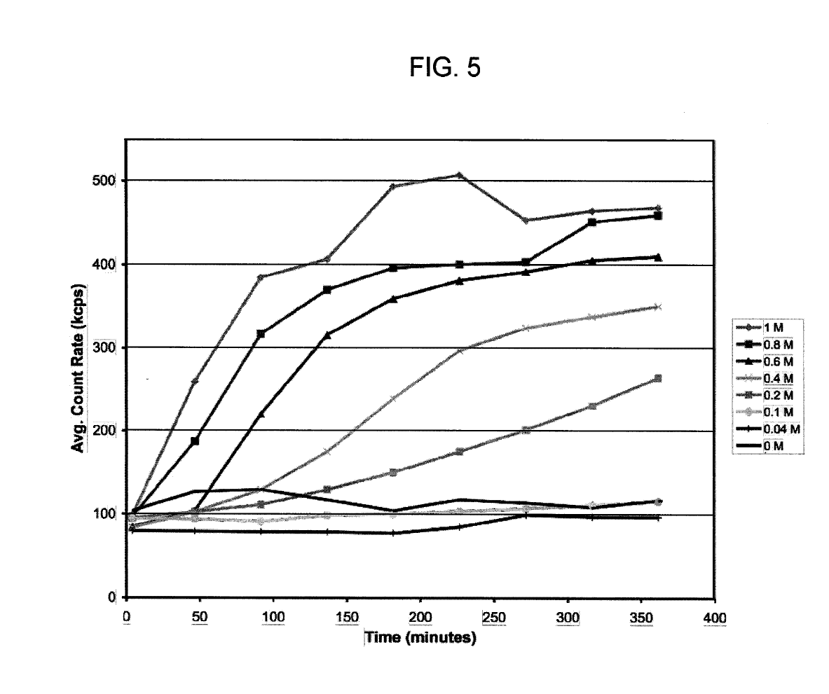

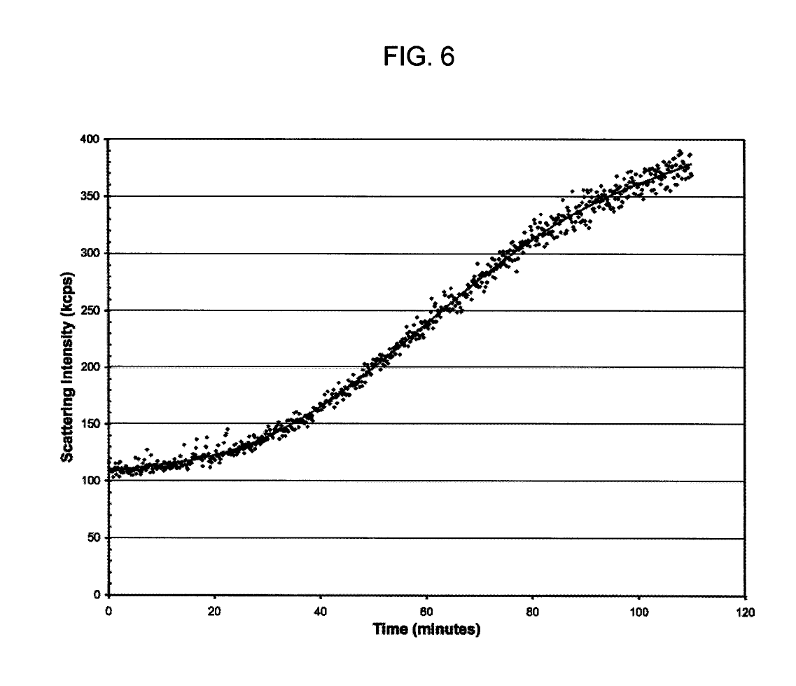

Scattering intensity was monitored after silicic acid was added to the polyamine aggregates after allowing the aggregates to sit for 30 minutes. Scattering intensity remained constant and then rapidly increased as condensation of silicic acid within the polyamine aggregates began (FIG. 5). The rate of growth of scattering intensity then peaked and slowed, with the timescale dependent on the concentration of silicic acid (FIG. 6). When a steady state was reached on intensity, hybrid nanoparticles consisting of a silica-encased polymer network were centrifuged and washed repeatedly.

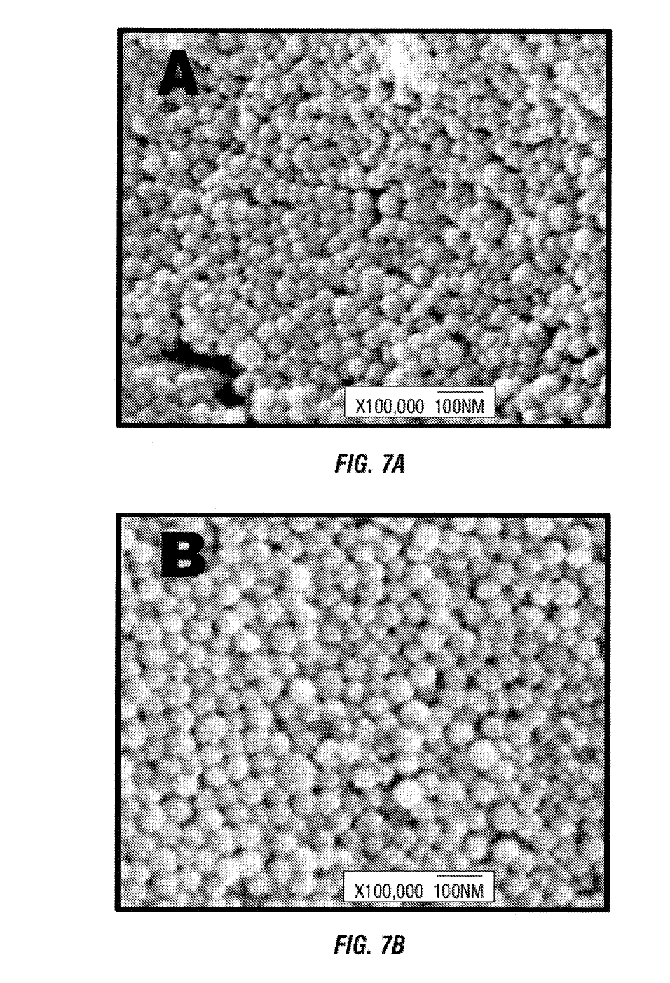

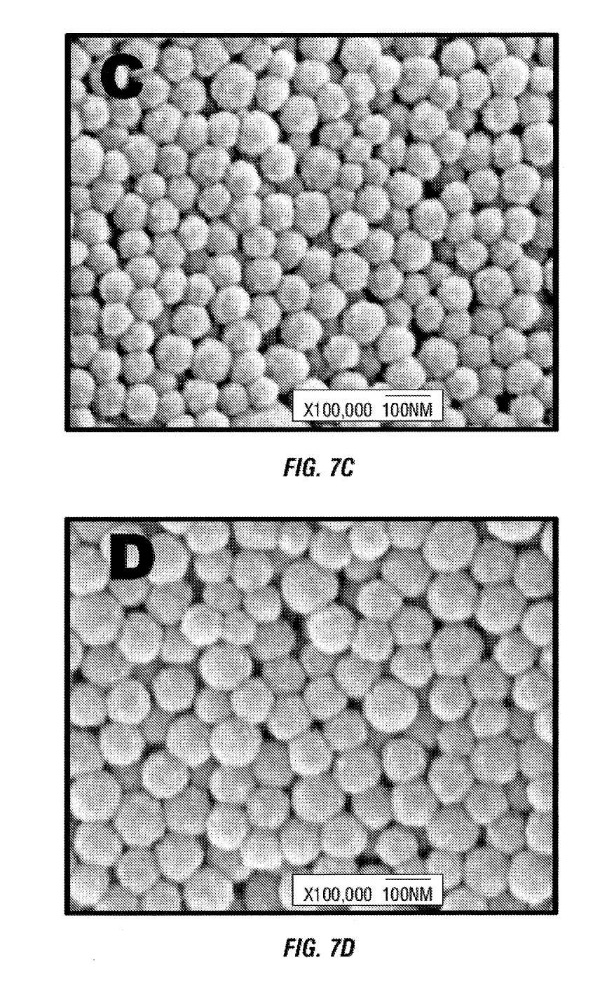

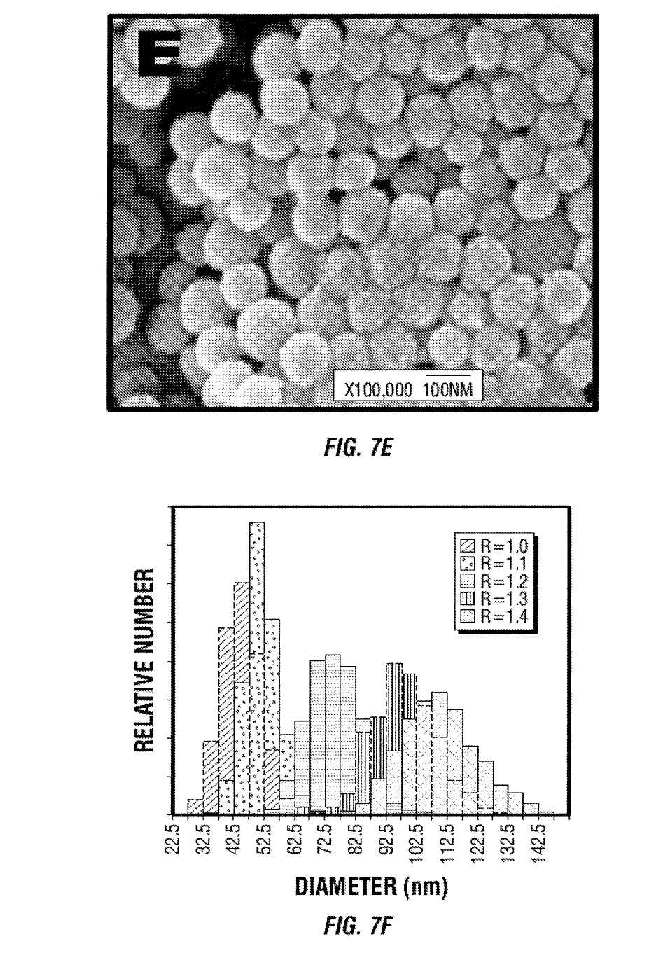

DLS revealed that the hydrodynamic diameter did not grow significantly after silicic acid was added to the aggregates. After the silicic acid condensed and locked in the aggregate structure, these hybrid particles were manually sized from scanning electron microscope images, and were found to be highly monodisperse (FIG. 7). As with aggregate size, hybrid nanoparticle size was closely correlated with R—higher citrate concentration led to larger aggregates, yielding large hybrid nanoparticles.

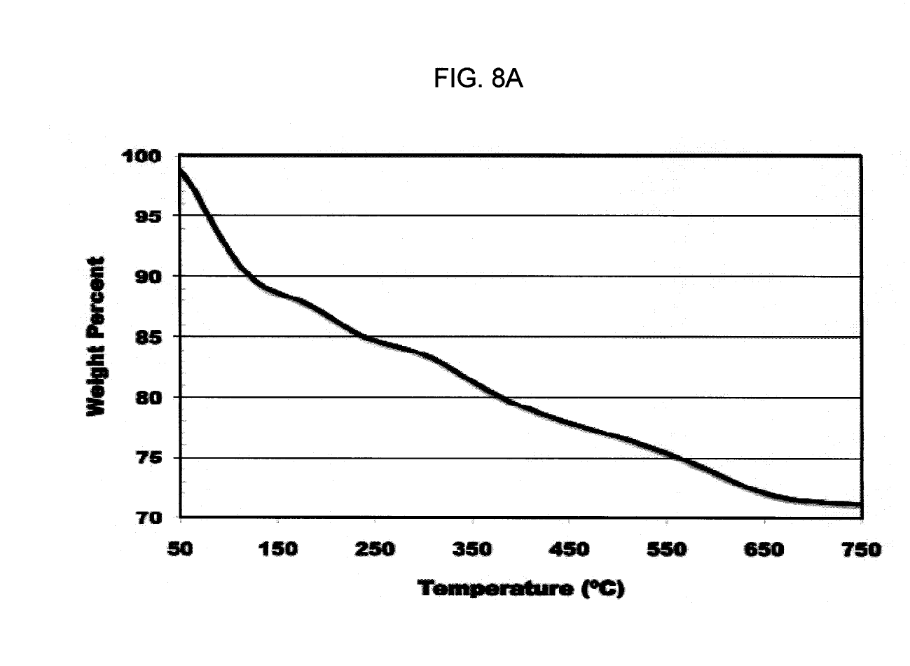

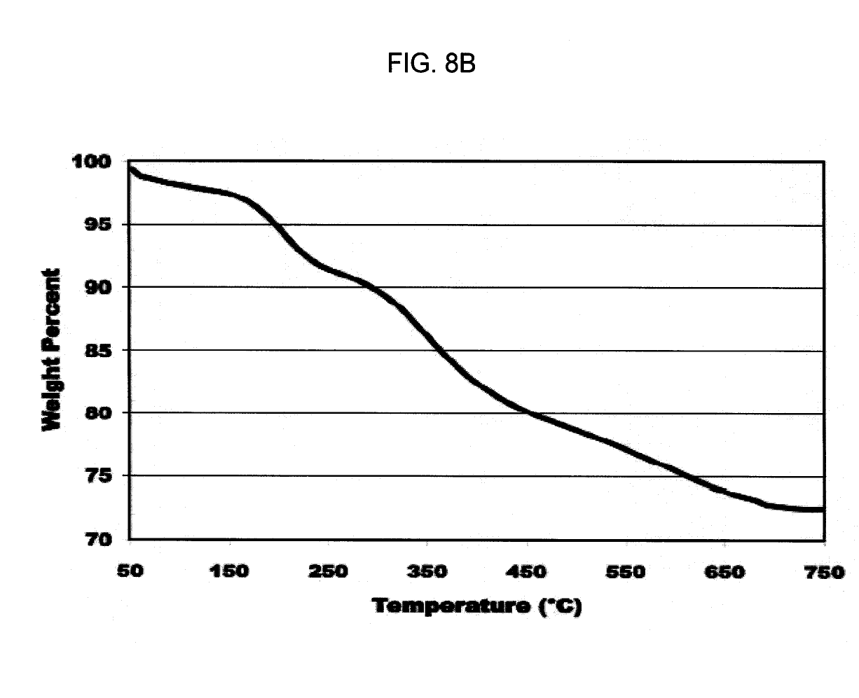

These particles did not have a shell structure. Microtoming particles made at higher concentrations and imaging with SEM revealed a solid and uniform core. Transmission electron microscope (TEM) images also suggested a solid core Thermogravimetric analysis of particles indicated a 75-80% inorganic composition (FIG. 8).

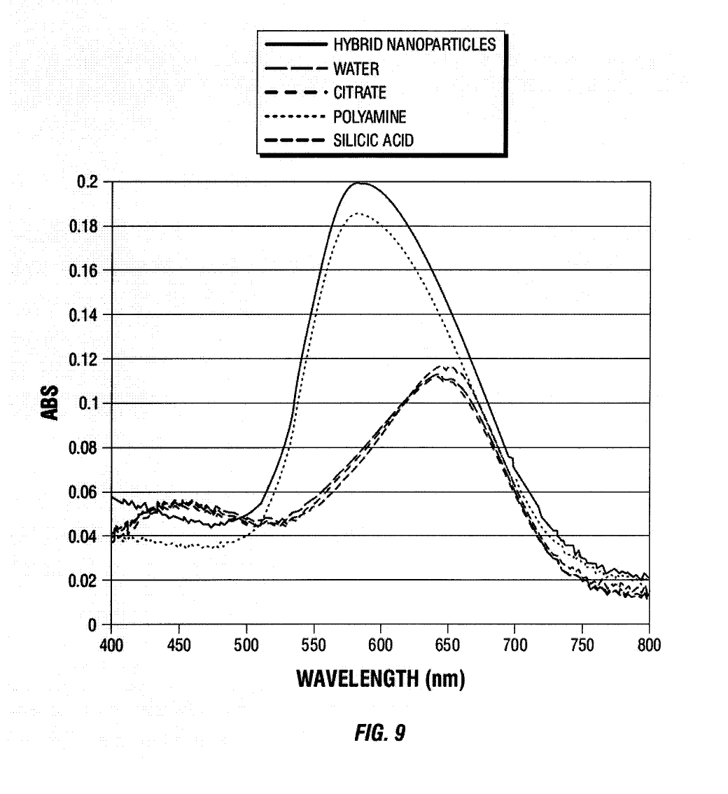

The nanoparticles exhibited positive surface charge due to surface amine groups and a high zeta potential (around +20 mV). This high zeta potential explains the stable non-aggregating nanoparticle suspensions. A solution of Coomassie brilliant blue G, turning blue in the presence of an acidic solution containing amines, was used to test for the presence of amines and indicated a significant polyamine presence on the surface (FIG. 9). If there were no accessible amines with which to react, then the Coomassie blue dye did not show a color shift.

Using the foregoing technique, SiO₂ NPs were synthesized with diameters as small as 28 nm. It is believed that still smaller NPs can be prepared using similar techniques by shortening the aging time, making the charge ratio R smaller, and/or lowering the temperature.

### Example 2

### Synthesis of Composite Nanoparticles with Plasmon Resonance

For growing a shell of gold on the hybrid nanoparticle surface, 1 mL of a concentrated suspension of washed composite nanoparticles was added to 40 mL of Duff gold nanoparticles and 4 mL 1 M NaCl. Duff gold nanoparticles were previously synthesized following the method reported by Duff, D. G.; Baiker, A. Langmuir 1993 8 2301 herein incorporated by reference. These nanoparticles had a negative charge because the surface was functionalized with alkaline tetrakis (hydrosymethyl) phosphonium chloride. Particle diameter was ˜2 nm. The solution was vortexed, sonicated for 30 minutes, and left for 24 hours in the dark at room temperature. The composite nanoparticles were isolated via centrifugation and washed. Various amounts of composite nanoparticles with attached gold nanoparticles were added to a 3 mL gold salt solution (0.25 mg/mL potassium carbonate, 0.355 mM HAuCl₄), ranging from 25 μL to 100 μL. 25 μL of 25% formaldehyde was added to this solution and the gold was reduced over several hours. This could be observed visually and with the UV-Vis spectrophotometer. Hybrid nanoparticles with gold shells were then isolated and washed via centrifugation for characterization.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

1. A method for making composite nanoparticles, comprising:
a) providing an amount of a polyelectrolyte having a charge;
b) providing an amount of a counterion having a valence of at least 2, the counterion having a charge opposite the charge of the polyelectrolyte;
c) combining the polyelectrolyte and the counterion in a solution such that the polyelectrolyte self-assembles to form a plurality of polymer aggregates and aging the solution for a time period ranging from about 1 second to about 12 hours, the plurality of polymer aggregates having an average diameter less than about 100 nm;
d) adding a silicon-containing precursor to the solution, wherein the silicon-containing precursor has a charge opposite the charge of the polyelectrolyte, and wherein the silicon-containing precursor comprises silicic acid, tetramethylorthosilicate, silicate salts, 3-aminopropyltriethoxysilane, 3-aminopropyltrichlorosilane, or combinations thereof; and
e) allowing the silicon-containing precursor to infuse each polymer aggregate and polymerize so as to produce composite nanoparticles, wherein the nanoparticles are monodisperse and unagglomerated.

2. (canceled)

3. The method according to claim 1, wherein step e) comprises allowing the silicon-containing precursor to infuse each polymer aggregate and polymerize for a time period ranging from about 1 minute to about 48 hours.

4. The method according to claim 1, further comprising after step e):
suspending the composite nanoparticles in a solvent to form a suspension; and
dissolving a metal salt in said suspension, the metal salt comprising a conductive metal, and
reducing the conductive metal onto the outer surface of the composite nanoparticles so as to produce composite metal nanoshells.

5. The method according to claim 4, wherein the conductive metal comprises gold, silver, palladium, platinum, lead, iron, copper, and combinations thereof.

6. The method according to claim 1, wherein the polyelectrolyte comprises a polyamine, a polypeptide, a polyacid, a polystyrenesulphonate, polyallylamines, polylysine, polyethyleneimine, gelatin, polyacrylic acid, gum Arabic, acacia gum, poly(diallyldimethylammonium) chloride, and combinations thereof.

7. The method according to claim 1, wherein the polyelectrolyte has a positive charge in solution.

8. The method according to claim 1, wherein the polyelectrolyte has a negative charge in solution.

9. The method according to claim 1, wherein the polyelectrolyte has a molecular weight in the range of about 1,000 Da to about 100,000 Da.

10. The method according to claim 1, wherein step a) comprises providing more than one polyelectrolyte.

11. The method according to claim 1, wherein the counterion has a valence of at least 3.

12. The method according to claim 11, wherein the counterion comprises a compound selected from the group consisting of carboxylates, phosphates, peptides, polypeptides, copolypeptides, glutamic acid, aspartic acid, or negatively charged polymers.

13. The method according to claim 1, wherein the counterion is a salt selected from the group consisting of citrates, carboxylates, sulphates, carbonates, trisodium salts of EDTA, tetrasodium salts of EDTA, and combinations thereof.

14. The method according to claim 1, wherein the counterion comprises at least one cationic counterion selected from the group consisting of peptides, polypeptides, copolypeptides, amines, polyamines, lysine, histidine, phosphates, polyacids, polystyrenesulphonates, or positively charged polymers.

15. (canceled)

16. The method according to claim 1, further comprising applying a shell layer to the composite nanoparticles, wherein the shell layer comprises comprise metals, metal oxides, metal nonoxides, organic particles, linear polymer, biomolecules, fullerenols or single/multi-walled carbon nanotubes.

17-20. (canceled)

21. The method of claim 1, wherein the composite nanoparticles are self-functionalized with organic groups protruding from the surface.

22. The method of claim 21, further comprising attaching antibodies, macromolecules, proteins, enzymes, ligands, receptors, peptides, organic fluorophores, biomolecules, organic molecules, or combinations thereof to the organic groups protruding from the surface.

23. The method of claim 1, wherein the polymer aggregates comprise polyamine.

24. (canceled)

25. The method of claim 23, wherein the composite nanoparticles comprise SiO₂.

26. (canceled)

27. A method for making composite nanoparticles, comprising:
a) providing an amount of a polyelectrolyte having a charge;
b) providing an amount of a counterion having a valence of at least 2, the counterion having a charge opposite the charge of the polyelectrolyte;
c) combining the polyelectrolyte and the counterion in a solution such that the polyelectrolyte self-assembles to form a plurality of polymer aggregates and aging the solution for a time period ranging from about 1 second to about 12 hours, wherein the polymer aggregates comprise polyamine and have an average diameter less than about 100 nm;
d) adding a silicon-containing precursor to the solution, wherein the silicon-containing precursor has a charge opposite the charge of the polyelectrolyte; and
e) allowing the silicon-containing precursor to infuse each polymer aggregate and polymerize so as to produce composite nanoparticles, wherein the nanoparticles are monodisperse and unagglomerated.

28. The method of claim 1, wherein the solution has a pH in the range of about 3 to about 10.

29. The method of claim 4, wherein the composite metal nanoshells have a tunable plasmon resonance.
